(19) United States
(12) Patent Application Publication
(10) Pub. No.: US 2015/0245092 A1
(43) Pub. Date: Aug. 27, 2015

(54) DIGITAL CONVERTER

(71) Applicant: Abilis Systems Sarl, Plan-Ies-Ouates (CH)

(72) Inventor: Matteo Butussi, Grand-Saconnex (CH)

(73) Assignee: ALi Europe SarI, Plan-les-Ouates (CH)

(21) Appl. No.: 14/431,742

(22) PCT Filed: Sep. 26, 2012
(86) PCT No.: PCT/EP2012/069004

§ 371 Date: Mar. 26, 2015

(51) Int. Cl. H04N 21/436; H04N 21/4385; H04N 21/438

(52) U.S. Cl. CPC H04N 21/43607; H04N 21/438; H04N 21/43853

(57) ABSTRACT

A digital converter device to distribute audio/video programs into an IP network, for example a Home network, or a WiFi LAN. It can receive one or more Transport Streams containing audio and/or video programs, and has plurality of programmable operational blocks that can selectively process transport stream sections, as well as an IP packet generator. Processing in operational blocks is determined by tags inserted in the sections of the transport stream, such that the operation of the converter is highly flexible and reconfigurable. Importantly, the device can be programmed to decrypt protected programs received as transport stream adding content protection measures where appropriate before their distribution in an IP network.

### FIELD OF THE INVENTION

The present invention concerns a method to convert digital signals and the corresponding device. More in particular, the invention relates to the conversion of digital signal containing a media stream into a format suitable to a packet network, for example an IP network. Applications of the invention include, but are not limited to, distribution of media content across a home network LAN, with or without Digital Content Protection measures.

### DESCRIPTION OF RELATED ART

Broadcast networks are used since the beginning of the television as the simplest and most economic mean to deliver signals to a wide number of consumers. With the transition to digital signals new standards, for example the DVB suite, have been developed to further increase the services for the final users.

In addition to these widely available satellite, cable, and terrestrial networks the development of high speed internet connections allows also to deliver TV services to any IP connected devices. These devices connected to the home network (like smart phones, tablets, IP set-top-boxes, games consoles, laptops, connected TV, etc.) are now capable to receive and decode video contents coming from internet network but still can't access legacy signals from broadcast networks.

In a typical home network scenario, the IP connected devices are able to access media content from the internet, but lack a physical tuner interface to access broadcast content. Digital tuner for the various broadcast standard exist in many cases, but they typically permit the reception only to the network node on which they are installed. Sharing of content across a home network is difficult or cumbersome. Besides that, these solutions do not allow easily the distribution of media across a network with content protection or conditional access measures.

Despite the proliferation of diverse broadcasting methodology (satellite, cable or terrestrial) and standard (DVB, ATSC or ISDB), digital media in modern broadcast transmission systems are almost universally formatted as MPEG Transport Stream. This format (shortly indicated as MPEG-TS, or MTS or TS) is specified by ISO 13818-1 or ITU-T Rec. H222.0 standards, though several variants and modifications exist. In the present document the wordings ‘Transport Stream’ and TS are used as convenient abbreviations to indicate standard TS stream or similar formats suitable for the transmission of audio/video streams. TS streams are composed by sections, also called packets, which may include a number of fields, called also sub-sections.

Fields in a given Transport Stream section may be called header fields when they carry different kinds of transport-related information, for example information about the section itself or the stream in which the session is embedded, or payload field, when they comprise the actual audio/video program that is the purpose of the transmission, suitably encoded.

The media content such transmitted can be open to all copying, reuse or recording (free-to-air streams), or protected by various conditional access mechanisms. Conditional access is for example used to limit the access to registered users, to provide added-value services, to protect pay-per-view content from copy, and so on. Usually the end user needs a smart card (SC) to decrypt the protected content. This feature is normally provided by a set-top-box developed by an operator to certify the security of the delivering mechanism up to the display. These systems guarantee the access to broadcast media, but only to the television set connected with the set-top-box.

In the case of internet-delivered digital media, the content can be protected using a digital right management (DRM) system which enforces control on all the actions done on such content (viewing, copying, forwarding, storing, etc. . . . ). Broadcast TS streams can be forwarded over IP local networks using a wide variety of protocols: some of them (like the Real Time Internet Protocol, or RTP) guarantee real time performances for video distribution reducing the latency while others, like for HTTP example, are more resilient to network errors.

The distribution of TS video streams over IP network is generally done between the production sites and the operator/broadcaster facilities via dedicated high speed networks. In the case of over-the-top (OTT) distribution, various protocols have been developed to provide the required quality of service (QoS) needed to deliver a high bandwidth service through networks that does not intrinsically guarantee delivery. Examples of such protocols are the Http Live Streaming (HLS from Apple), Adobe Dynamic Streaming (from Adobe) or Microsoft Smooth Streaming. Such systems, however, require high-bandwidth IP connections from the production sites to the final user. Moreover, they are not easily adaptable to changing stream protocols and content protection systems.

US2009075585 published 2009 Mar. 19 discloses a system for receiving wireless digital video transmissions over a WLAN. This document describes a form of conditional access to selected contents that is, however, entirely implemented among the content provider and the set-top-box, the home network infrastructure being totally oblivious to access management.

US2009268807 published 2009 Oct. 29 discloses a system for forwarding video streams on IP packet networks with a sensitive-information-parts generator and a transcoder adapted to encode SIP areas with a higher bit rate than non-SIP areas.

There is therefore a need for a system that allows the reception of content-protected media without placing excessive burden to the network in terms of bandwidth and quality of service, and the distribution of free and protected media in a network.

Another shortcoming of the known techniques of transporting media stream in IP packet networks, is that they do not guarantee a deterministic execution time, in the sense that the time needed to process a given stream cannot be determined a priori. As a consequence, it is difficult to reliably maintain with these systems the QoS level required by high quality media reproduction.

Further, an object of the present invention is the provision of a scalable and re-programmable method/device for multi transport streams processing.

Moreover, an aim of the present invention is to provide, a conversion system with deterministic execution time.

### BRIEF SUMMARY OF THE INVENTION

According to the invention, these aims are achieved by means of the object of the appended claims.

FIG. 1 shows a schematic representation of system of the invention. A set of streams 15, 16, 17 carrying information, for example TS streams, are received by the converter unit 100 that is in charge of extracting the information, of transcoding the information from one format to another one and of other processes. The streams 15, 16, 17, could originate from any suitable source, for example a DVB receiver demodulating broadcast DBV signals, or an internet source. This information is retransmitted to devices 300, 400 and 330 in a different format or after being processed.

Packet data are exchanged between the different nodes in the network of FIG. 1 and any available external network, for example the internet, under control of block 200 that might be a router, a switch or any suitable networking device, which knows the requests of end nodes and may additionally requests from converter 100 to extract and process the media-relative information. Nodes 200, 300, 400, together with the router 200 and the converter unit 100 belong for example to a packet Local Area Network, like for example a domestic TCP/IP LAN based on wired Ethernet, WiFi, PLC, and/or any suitable physical layer. The following description will make reference for concision's sake, to a Local Area Network or a Home network. It must be understood, however, that the invention is not so restricted and does include also instances of conversion in virtual LANs, including remote nodes through appropriate tunnels or VPN connections, and WANs, comprising fixed and/or mobile nodes.

FIG. 2 shows a schematic representation of a possible embodiment of converter unit 100. The invention merges a given number of streams 15, 16, 17 in one single stream, tagging the sections and adding, if necessary, extra information. The packets carried by the generated stream are than processed by the subunits 102, 103, 110, 104, 105, of FIG. 2. The blocks of the chain are all preferably programmable and reconfigurable by the supervising controller 112 that arranges the subunits in such a way to generate at the output the desired set of output streams in a different format from the streams at the input.

A possible application of this invention is the transcoding for Transport Streams to IP Streams. Each sections of the stream generated by multiplexer block 101 is modified, in succession, by the chain of processing subunits 102, 103, 110, 104, 105. Preferably, each of them is arranged to recognize the received section by tagging data inserted in a suitable available field of the MPEG by one or several of the previous subunits. Once the unit has recognized a given section from the tagging, it applies a predetermined corresponding process using the information coming from the controller 112.

In the frame of the invention, the processing subunits acting on the stream sections can be implemented by software processors, or as hardware units. In the latter case, the processing subunit can work on the continuous main stream, as depicted for subunits 102, 103, 104, 105. Subunit 110, on the contrary, represents a software processor programmed to modify the stream sections stored in buffer 114 according to a program of instruction received from the supervising controller 112. Buffer memory 114 absorbs the non-deterministic execution time of software-implemented subunit 100 and guarantee even-timed output streams suitable for a smooth media reproduction. Hardware units are also preferably programmable, for example in the sense that the process that they apply to selected section of the transport stream depends from the content of programmable registers set by the supervising controller 112.

### BRIEF DESCRIPTION OF THE DRAWINGS

The invention will be better understood with the aid of the description of an embodiment given by way of example and illustrated by the figures, in which:

FIG. 1 shows schematically a possible application of the invention in a home network.

FIG. 2 represents in a schematic fashion a possible structure of the converter unit 100 of the invention.

FIG. 3 shows schematically the structure of a transport stream processed by the inventive converter.

FIG. 4 is a schematic representation of a possible architecture of the invention.

FIGS. 5 and 6 represent the streams processed by the invention and presented at the input of the inventive converter 100.

FIG. 7 illustrates how the converter of the invention inserts conversion-specific tags in the transport stream.

FIGS. 8 and 9 illustrate examples of the action of descrambler unit 2, respectively by transcoder unit 3 of FIG. 4.

FIG. 10 shows schematically how the converter of the invention can be rescaled to increase its computational capacity.

FIG. 11 represents schematically a possible architecture for the invention having a double parallel processing chain.

FIG. 12 represents schematically a possible architecture for the invention in which the subunits are reconfigurable by the supervisor processor 112.

### DETAILED DESCRIPTION OF POSSIBLE EMBODIMENTS OF THE INVENTION

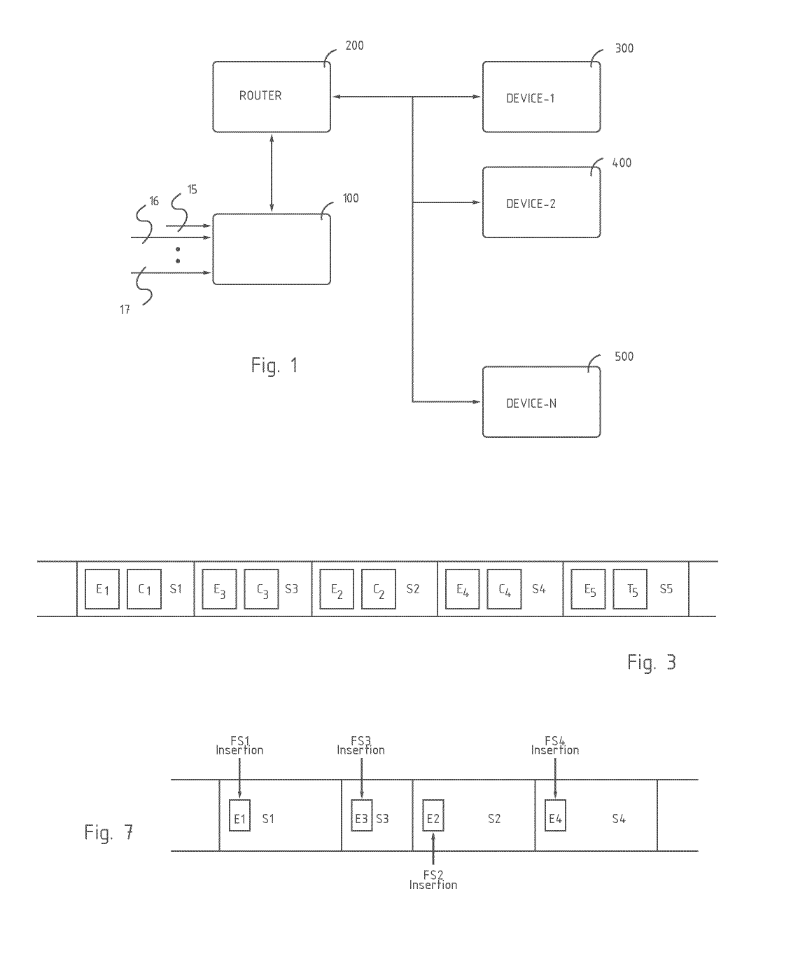

A possible implementation of the invention will now be discussed with reference to FIG. 1. The converter of the invention has one or more input for digital data streams 15, 16, 17. The data streams 15, 16, 17 are for example streams of data formatted according to the MPEG transport stream standard discussed in the introduction, or another stream format compatible with the invention. The digital streams 15, 16, 17 may come from a DVB demodulator, or any other suitable source and are fed to the conversion unit 100 that includes the technical means to carry out the conversion of the inventive method. The converter unit 100 is part of a network, for example a Home network comprising the devices 300, 400, 500 that may be personal computers, tablets, smartphones, IP television sets, and so on.

In a typical implementation, the network represented in FIG. 1 will be a home network, possibly a WiFi network and rely on a router 200, or another similar network device to manage the packet exchange among network's nodes, and for connection to the internet or another wide area network. The invention could however be applied to any kind of networks including those including device connected via a cellular phone network or the internet.

In operation, the end devices 300, 400, 500 may request access to an information or a program contained in one of the incoming streams 15, 16, 17, for example by addressing a request to network device 200. The latter is aware of the content of incoming streams and forward appropriate instructions to converter block 100 to extract from the requested program from the relevant incoming streams. The requested information is transmitted by converter unit 100 to router 200 in a suitable format, for example a format by the router 200. The router forwards then the information received from converter unit 100 to the requesting device.

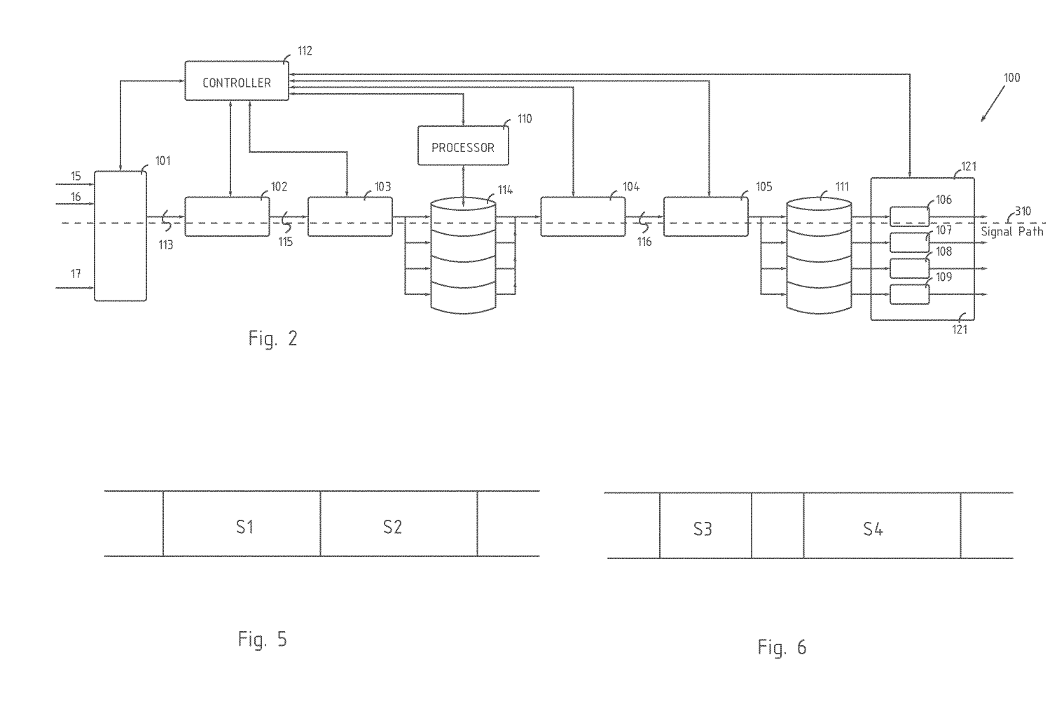

FIG. 2 shows in a schematic fashion a possible structure of that. Sub-unit 110 in this example is software-implemented, and is preferably connected to a buffer memories 114 to absorb non-deterministic processing time. Buffer memory 111 fills the same function with respect to the output unit, or demultiplexer, 121. Other sub-units, for example 102, 103, 104, 105, are fast enough to carry out the relative conversion tasks in a short and predictable time, and hence are directly inserted in the signal path, without buffering. All the conversion chain is controlled by the supervising controller 112.

With reference to FIG. 2, the converter unit 100 of the invention is arranged to convert N incoming streams 15, 16, 17, . . . into M output streams 106, 107, 108, . . . changing the stream format. It can be represented as a chain of operational blocks or subunits, in this case indicated by reference numbers from 101 till 110 on a signal path 310.

The N incoming streams 15, 16, 17, . . . are merged into one single stream 113 by multiplexer 101. The generated signal 113 is processed by a cascade of subunits 102, 103, . . . 110 each of which is arranged to modify the stream in different ways and can perform different processes on the signal flow, for example either or more of the operation in the following non-exhaustive list: (a) adding information; (b) changing the tables used to describe the stream itself; (c) decrypting contents; (d) encrypting contents; (e) changing content format; (f) removing information; (g) splitting one input stream into more output streams having all, or part, or none of their content in common; (h) joining more input streams into one output stream combining content from several input streams, and so on.

In this embodiment of the invention, each all the subunit lay on the same signal path 310, and each of the stream's sections is processed by all the subunits in succession, though same of the subunits may selectively pass transparently some section to the following one, without altering its content. Other variants, as it will be seen later, sport different signal paths.

All the operational blocks are controlled and programmed by the supervising controller 112 that controls all the blocks and decides the process performed by each of them. According to this variant, the invention receives a plurality of transport streams 15, 16, . . . 17, which are processed by operational block 101. Block 101 filters the useful sections of the received streams and merges these sections in a single stream 113.

The controller 116 decides which section of the received streams must be selected and merged in the compound signal 113 and program or instructs accordingly the multiplexer 101. The latter optionally can insert an additional field in selected section, reporting information useful for further processing by other operational blocks along the signal path. The function carried out by the operational blocks on the signal path 310 can be manifold, as explained above.

The information added in additional fields by the converter of the invention shall be named in the following extrinsic information or equivalently e-information. All the operational blocks of the chain can modify the e-information and different kinds of e-information can be carried by this field, for example:
Information concerning the source of the selected section
Information concerning the type of process to perform on the given section
Information concerning the information carried by the given section

The e-information is used by the operational blocks to identify the sections and/or know the process to perform on a given section. In many kinds of stream there are fields that are defined but not presently used in the standard. It is often the case when spare field are reserved for a future use that is not yet implemented, or for the specific purpose of carrying additional information not defined by the particular stream coding in use. In such cases, the unused fields can be used to carry the e-information.

While in many cases the sections in the stream move along the sections by passing directly form an operational block to a subsequent one, they can also be temporarily stored in memory. In FIG. 2, signals 113, 115 and 116 are streams carrying sections, while blocks 114 and 111 are buffer memories in which the sections are temporarily stored. In both cases the sections stored in the buffer memories have an e-information field.

As already mentioned, not all the operational blocks are directly placed on the signal path. Those working on data temporary stored in memory, named also processors in this document, load data from a memory, process the data, and rewrite the processed data in the same memory, or in an another one. In FIG. 2 there are two memories 111 and 114 and there is one processor 110. The processor 110 in this example acts on the different memory's areas in different ways, based on a knowledge of the memory partitioning and of the process to apply. Both the knowledge of the memory partitioning and of the process to apply could be included, for example, in a program executed by the processor 110 and defined by the supervising controller 112.

Preferably the processors on the signal path are fully programmable and configurable. The execution time of the processes assigned to this block can strongly vary from one configuration to another one, and depend from interrupts, workloads or other events in a manner that is difficult to determine a priori. The memory 114 is used to absorb the variations in execution time and guarantee the correct functioning of the blocks before and after the processor. The partitioning of the memory used by the processor is preferably based on the execution time of the assigned processes and on the throughput of the incoming/outcoming data.

There are other operational blocks having input or output connected to a memory. Block 103 processes the stream coming from block 112 and stores the results of this process in memory 114. Block 104 loads the section to process from the memory 114 and generates a stream 116, comprising all the processed sections.

FIG. 3 shows in a schematic fashion a possible representation of the stream built up and processed by inventive device. The stream is partitioned in sections (S₁, S₂, S₃, S₄ and S₅) each of which includes information organized in fields that may be e-information fields (E₁, E₂, E₃, E₄ and E₅) for example extrinsic information relative to the destination of the individual section in the stream, or the address of the intended recipient node, the actual audio/video content that is the purpose of the transmission (C₁, C₂, C₃ and C₄), or tables (T₅) used to describe the architecture of the stream itself. All the operational blocks and all the processors can modify the fields carried by a section. They can modify the e-information, the contents and the tables.

In the MPEG transport stream standard the table is also named Program Specific Information (PSI). The MPEG standard defines four different tables: (a) Program Association (PAT); (b) Program Map (PMT); (c) Conditional Access (CAT); (d) Network Information (NIT). The MPEG-2 specification does not specify the format of the CAT and NIT.

Reverting to FIG. 2, the output streams are generated by a set of IP generators or other packet generation means 106, 107, 108, 109 having as input a partition of a memory 111. All of them are programmable and/or configurable by the supervising controller. This last part of the architecture permits to efficiently absorb all the delay previously introduced in the chain and then to generate output streams suitable for guaranteed Quality-of-Service System.

### Practical Application: From Multi Transport Streams to Multi IP Streams

FIG. 4 shows in a schematic fashion a possible structure of the inventive converter unit 100 of the architecture of this invention. Converter 100 is able to receive a plurality of content streams 15, 16, 17, possibly protected, and to transmit the received information as 9. 10. 11. 12, also optionally protected. The converter 100 comprises a plurality of operational blocks under the control of a supervisor controller 13. Each operational block can perform a given set of configurable operations. The supervising controller programs the blocks of the chain and determines in this way.

A set of streams, 15, 16, . . . , 17, are merged by multiplexer 1 into a multiplexed signal 14 that includes the useful sections of the original input streams. In the following, the generic i-th useful section filtered by Block 1 will be denoted by Sᵢ. Preferably, the selection of the useful sections is done using the information and the requests coming from the controller 13. Multiplexer 1 adds at each useful section a new field reporting e-information useful for the following processes. The e-information of the i-th section will be denoted by E_i. Signal 14 carries a stream of useful sections encapsulating the e-information Eᵢ and/or contents Cᵢ.

The packets of signal 14 carrying protected contents are decoded by a descrambler 2 or another suitable decoding means. The output of the de-scrambler can be translated, in transcoder sub-unit 3, into another format carrying the same information, Ex: from MPEG2 to MPEG4 or vice-versa.

The stream 19 generated by the transcoder 3 is filtered by the Stream Filter 4 that selects the useful packets from the incoming stream and writes the selected packets in different sections of the memory 5. The data of each memory section can be processed in different ways by a programmable processor 6. After the processing is performed by the processor the data are loaded from the memory and processed by the scrambler sub-unit 7 whose function is to apply content protection means to those sections and fields of the stream that require them. The output of the scrambler is stored in another memory 8 which is used a buffer by a set of IP generators, 9, . . . 12. The IP generators load the sections from the memory 8 and encapsulate the payload in IP streams. All the process is controlled by the supervising controller 13 that programs and controls the operational blocks on the signal path.

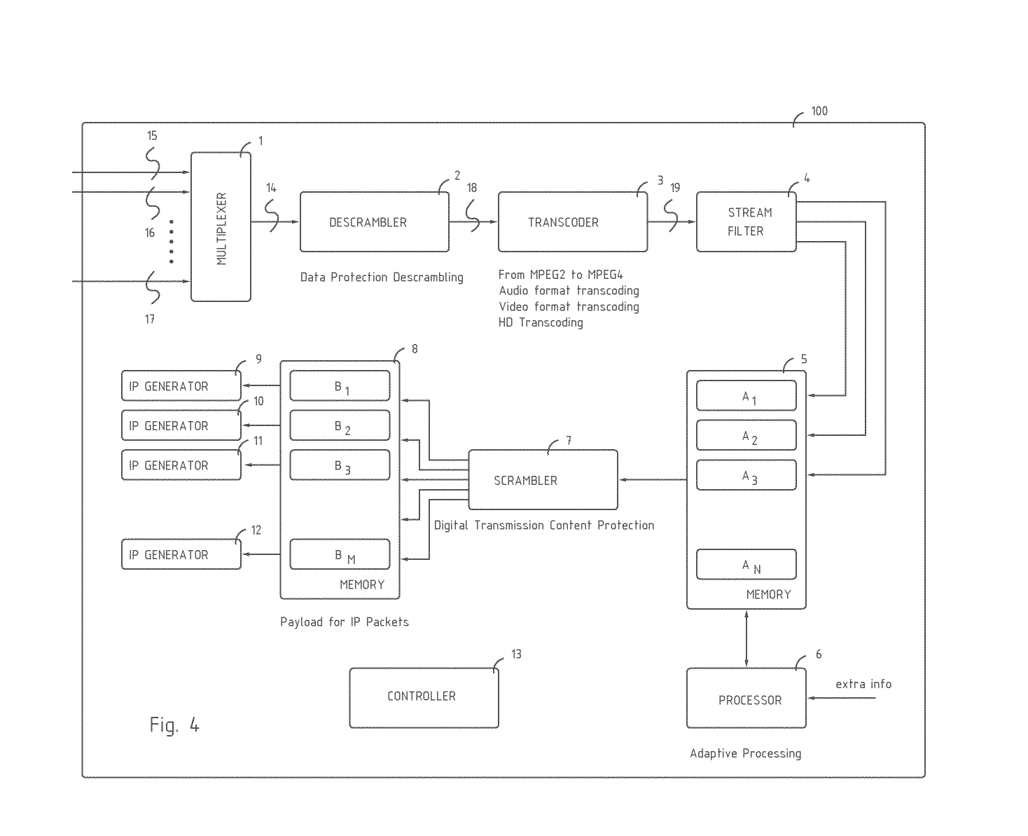

FIG. 7 shows in a schematic faction a possible representation of the stream generated by multiplexer 1 of FIG. 4 or the same unit 101 of FIG. 2. The stream is the merge of the streams respectively reported in FIG. 5 and in FIG. 6 that will be also indicated as stream-a and stream-b. In this example, each stream carries two useful sections. Stream-a carries section S1 and section S2, while stream-b carries section S3 and section S4. Stream-a and stream-b may include many others sections not considered as useful section by the system. For sake of simplicity these sections, considered useless, are not reported in FIG. 5-6. F_{S1}, F_{S2}, F_{S3}, F_{S4} indicate the e-information added in the stream by the. In a variants of the invention, information can be either added in already existing but unused fields of section 1, 2, 3, and 4, or carried by new fields inserted by the converter unit.

The sequence of the filtered sections in the signal 14 depends on the configuration of block 1. There is no guarantee that the order in combined stream 19 reflect the order of sections in input streams. The sequence in FIG. 7 is (S1; S3; S2; S4). Nevertheless it could be different, (S1; S4; S3; S2), (S1; S4; S2; S3), etc.

In many standards the stream’ sections include empty fields, not defined fields reserved for future use. Such fields can be used by block 1 to carry the information, for example, FS1, FS2, FS3 and FS4. In such case block 1 does not add any extra field in the useful section but load in the already existing fields the extrinsic information. Then, signal 14, generated by block 1, is decrypted by descrambler block 2. According to an aspect of the invention, Block 2 selectively applies decryption and select which kind of decryption is applicable to the sections in stream 19 based on the extrinsic information. It could happen that not all the incoming sections carry protected contents. In such a case, block 2 identifies sections carrying clear content, for example based on the e-information in the section (or absence thereof), and does not apply any decryption process to those sections. Optionally, descrambler 2 could leave some protected contents undecripted and/or selectively change the e-information carried by some section, for example to indicate that a particular section has been deciphered.

The stream 18 generated at the output of descrambler 2 carries all the sections of signal 14. Since e-information and contents of the sections can be changed by descrambler 2, they will be respectively denoted by E_i and by C̅ᵢ. If the e-information of the i-th section has been changed, then Eᵢ≠Ēᵢ, otherwise Eᵢ=Ēᵢ. Likewise decryption of the contents of the i-th section implies Cᵢ≠ C̅ᵢ, otherwise Cᵢ= C̅ᵢ.

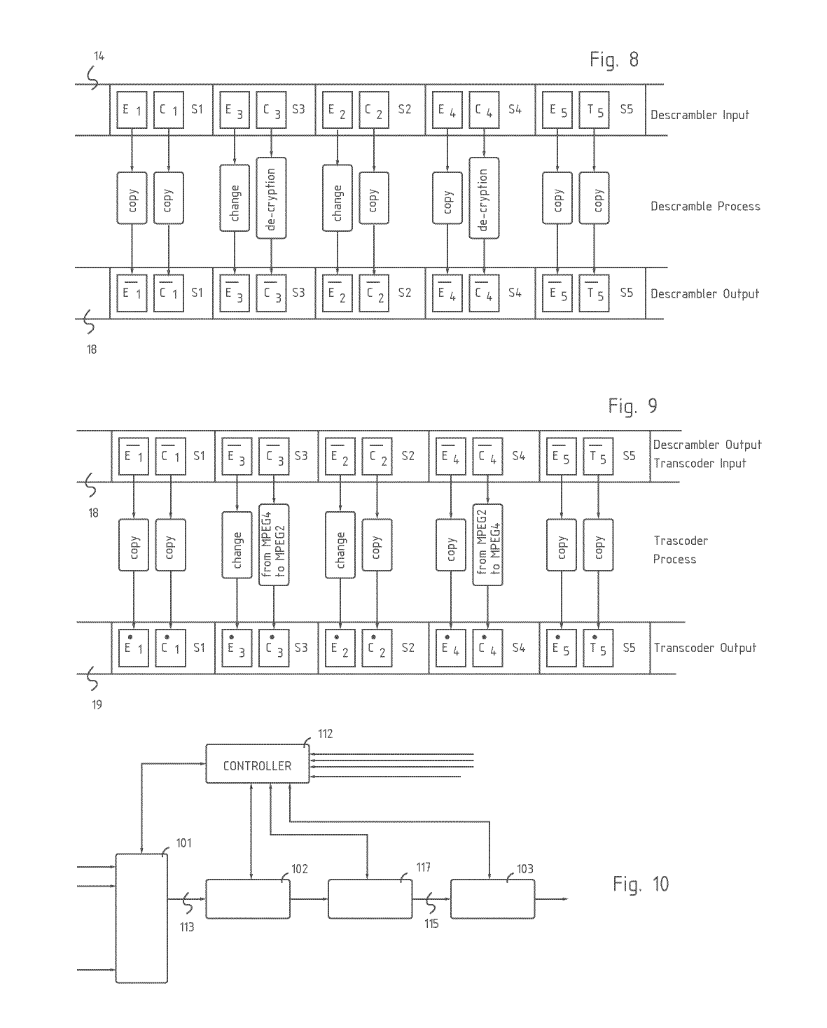

FIG. 8 shows in a schematic fashion an example of the processes performed by block 2. Section 1, (S₁), is not modified by descrambler 2, both e-information and contents, are copied from section 1 of signal 14 to section 1 of signal 18 without changes: E₁=Ē₁, C₁= C̅₁. Block 2 modifies the e-information and decrypts the contents of section 3 (S₃): E₃≠Ē₃, C₃≠ C̅₃. The e-information carried by section 2 is changed, but the corresponding contents are not modified: E₂≠Ē₂, C₂= C̅₂. Section 4 is partially modified by descrambler 2, in that the e-information is not changed, but the content is decrypted: E₄=Ē₄, C₄≠ C̅₄. Finally, Block 2 does not modify the tables carried by signal 14. It copies S₅ without any change: E₅=Ē₅, T₅= T̅₅.

The output 18 of descrambler 2 is processed by transcoder block 3 that can change the format of the contents and also the e-information. Assuming video and audio contents, block 3 can for example change the format from MPEG2 to MPEG4 and vice-versa. Preferably, descrambler 2 selectively applies transcoding to sections in the stream 18 based on the respective e-information, or absence thereof. The e-information and the contents carried by the i-th section after the process performed by block 3 will be denoted by Ėᵢ and Ċᵢ, respectively. The output 19 of block 3 will be denoted by signal 19. The transcoding process performed by block 3 on the different sections are preferably defined by the supervising controller 13.

FIG. 9 shows in a schematic fashion an example of the processes performed by block 3. Block 3 copies section 1 and section 5 without any change: Ē₅=Ė₅, T̅₅=\dot{T}₅, Ē₁=Ė₁, C̅₁=Ċ₁. For other sections block 3 changes the e-information and/or translates the format contents. In this example, C̅₃̅ and C̅₄̅ carry data respectively in MPEG-4 and MPEG-2 format. Block 3 modifies C̅₃̅ and changes the data format form MPEG-4 to MPEG-2. While in case of C̅₄̅, the block modifies the data format from MPEG-2 to MPEG-4 without modifying the e-information of section S₄. Section S₅ is not modified; it goes through block 3 without changes.

The output 19 of block 3 is processed by the Stream Filter 4 This sub-unit takes the sections carried by signal 19 and copies them in different areas of memory 5 of FIG. 4, or also memory-A. The i-th area of memory-A is denoted by A_i. Preferably the way to load the sections in the memory areas is predefined by the supervising controller 13.

The data stored in memory-A are processed by the Processor 6, which loads the data from memory-A and processes them in different ways, for example: (a) modifying the e-information, (b) merging contents, (c) adding, removing and/or changing tables, etc. The process to perform on A_i is preferably predefined by the controller (block 13) and depends from the e-information of each section.

Scrambler 7 has means to know which memory areas have been already processed by the processor 6. It loads the processed stream sections from those areas and optionally protects the contents. The way to protect the contents is defined by the supervising controller 13 and, preferably is dependent from the relative e-information in each section. The output of Block 7 is written in a memory 8 denoted also as memory-b. Scrambler 7 can encrypt all or part of the sections stored in memory 5, for example according to the DTCP standard, or apply any suitable content protection measure. It can change all or part of the e-information and it can change all or part of the tables stored in memory.

The last process of the invention is performed by IP generators 9, 10, 11, and 12. These blocks load the sections previously stored in the b-memory by scrambler 7 and insert the relative contents in M IP Streams 1, 10, 11, 12. Preferably, each of these blocks is associated to a given memory area and processes only the sections stored in such area.

In a non-illustrated variant, the IP generators could be replaced by Transport Stream Generator, or other formatting means, arranged to generate output streams a in any suitable format, preferably different from the format of input streams 15-17.

### Transcoder for QoS System

According to an inventive aspect, the converter 100 is suitable for QoS System because it is able to generate, in a predetermined processing time, M IP streams having predetermined rates. The processing time can be predetermined by the supervising controller 19 because the processing time of the operational blocks having as input and/or output the main stream is deterministic and because all the not well controlled processing time introduced by the processors is absorbed by memories.

In the example of FIG. 2 there is one processor, block 110 whose execution time, being it mainly implemented by software, cannot be easily determined a priori and with certainty. Nevertheless it is possible to determine an average processing time and upper bound, also known as worst case, for the processing time of this block. The memory 5 associated to this block is then properly designed in such a way to absorb the maximum processing delay.

Moreover, in many cases in the process for transcoding from N Input Streams to M Output Streams there is a block used to change the content format, for example transcoder block 3 in FIG. 4. In case of transport stream transcoding, Block 3 can change the content format from MPEG-2 to MPEG-4, from MPEG-4 to MPEG-2 and it can change the content quality, Ex: from HD (High Definition) to SD (Standard Definition) and vice versa. This flexibility of the transcoder can be used by the controller to better avoid process-overload problems in the architecture proposed by this invention. For example, the supervising controller 19, or another monitoring unit in converter 100, could be arranged to monitor QoS and dynamically adapt the transcoding, for example lowering the definition, or switching to an encoding having a higher compression ratio, or a lower computational burden, when QoS falls below a determined level.

### Scalable Solution

This invention proposed a scalable solution for TS Transcoding. Since each operational block is blind about the final goal of the system, and its process is determined by the e-information, the system can be easily increased adding more than one operational block performing the same process.

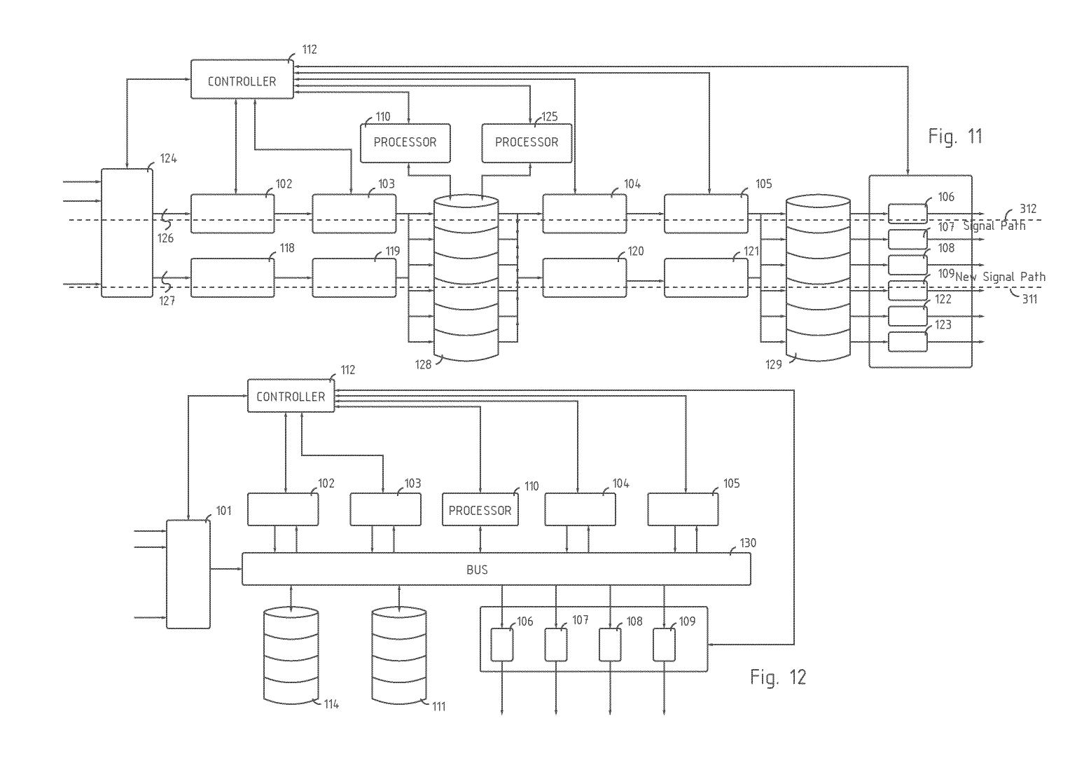

FIG. 10 shows in a schematic fashion a way to increase the computational capacity of the system with minor changes in the system architecture. The system comprises, similarly to that of FIG. 2, a multiplexer 101 and a chain of operational blocks 102, 117, 103 that are programmed by supervising controller 112 in order to process the sections of stream 113 in a manner that is determined by e-information fields injected in the section by multiplexer 101. For the sake of simplicity, let's assume that block 102 be requested to process four sections S₁, S₂, S₃ and S₄ but that it has the computational capacity only for two of them within a given time. In such case the system can be modified adding another block having the same functionalities and the same computational capacity of block 102. In FIG. 10 this block is denoted by block 117. Block 117 has as input the output of block 102 and executes the processes for which block 102 does not have the capacity. In this way block 102 could process S₁ and S₂ and forward S₃ and S₄ to subunit 117 without modifications. Subunit 117 would determine form the e-information that sections S₃ and S₄ still need processing, and that S₁ and S₂ have already been processed. Accordingly it would process S₃ and S₄ and forward S₁ and S₂ without modifications. The signal 115 at the output of block 117 carries the four sections all processed as requested by the controller (although not necessarily in the same order as in signal 113). The cascade of block 102 and block 115 is equivalent to a block having the same functionalities of block 102 and twice its computational capacity.

The division of the processing tasks among functionally equivalent subunit is preferably determined by the e-information that is inserted by multiplexer 101 and according to a program determined by the supervising controller 112.

Another possible solution to increase the computational capacity of the architecture is to parallelize the processing. If assume that the chain reported in FIG. 2 does not have the computational capacity for the transcoding process requested, further capacity can be introduced by a parallelization of all the processes as shown in FIG. 11.

Several of the blocks of the chain are duplicated. Block 118, block −119, block 125, block 120, and block 121 are respectively equivalent to block 102, block 103, block 104 and block 105. Block 122 and block 123 are equivalent to block 106, block 107, block 108 and block 109. The system memories 128 and 129 are preferably increased, with respect to those required in a single-path implementation, in order to cope with the higher data throughput. The first subunit 124 of the chain is a multiplexer corresponding functionally to block 101 in FIG. 2 and is able to generate two output streams each of them carrying sections of the input streams. The two generated streams are then processed by the two parallel signal paths 311, 312. The two memories, block 128, allow passage of information across the data paths so that a given section can be processed, for example by block 118, 119 on path 311 and later pass to path 312 by memory 128 to be further processed by blocks 104, 105, and so on.

The supervising controller 112 in has the same functionality in this variant than in that of FIGS. 2 and 4, except that it must manage a larger number of operational blocks. Not all the connections between the supervising controller 112 and the operational blocks are visible in FIG. 11, to avoid cluttering the drawing.

The operational blocks on signal path 102 are functionally equivalent to those of FIG. 2, with the same reference number. The subunits on path 311 are also functionally equivalent to those on path 312: block 118 is equivalent to block 102, block 119 is equivalent to block 103, block 120 is equivalent to block 104, block 121 is equivalent to block 105 and block 122 and block 123 are both equivalent to the blocks 106, . . . 109.

Perfect equivalence between the blocks is not always necessary. Block 118 could have the same functionalities of block 102 but not the same computation capacity. For example, its processing time could be longer. On the other hand, certain processing that are required only for a small fraction of the sections in the stream, may not be replicated in subunit of both signal paths 311 and 312.

Multiplexer 124 reported in FIG. 11 is able to generate two parallel outputs, and is otherwise functionally equivalent to block 101 of FIG. 2. Output signals 126, 127 are a merge of a given subset of useful sections carried by the input stream. The two signals at the outputs of block 124 could or could not carry copies of the same section.

Having two streams at the output of block 124 gives the system the flexibility to process the same section in two different ways and to generates two different output carrying the same contents but in a different format. Let's assume that a given section carries HD contents, the invention is able to generate two output streams carrying the same contents but in a different format. To this purpose block 124 can generate two streams, signal 126 and signal 127, carrying the same section. The system can then decide to change the contents format, from HD to SD, for only one of the two signals. In this way, at the end of the chain the system can map on one output stream, ex signal 123, the HD content format and on another one, ex signal 106, the SD content format. Note that the two copies of the same section cannot be confused because the system takes care to tag them differently using the e-information.

The two memories 128 and 129 permit a given section to be processed by both paths of this architecture. Let's assume that an input section is mapped by block 124 onto signal 127. Such section will be processed by block 118 and block 119. Once it has been stored in block 128, the section can be independently produced by block 110 and/or block 125. After this process, the section can be loaded from the memory by block 104 and/or block 120. Note that both blocks can load the same section from the memory. In this case two copies are distinguished by a different e-information. This is the reason why, it could happen that a given section is processed first by block 118 and then by block 104.

### Architecture for Cloud Computing

According to another variant of the invention, the converter 100 is realized with structure that makes it suitable for Cloud Computing, and allows to change the order of action of the various sub-units. In the variants previously presented, the order of the sub-units along the signal path is hardwired, and sections in the stream are passed from one subunit to the next one. This structure can be changed to provide a flexible and reconfigurable succession of sub-units for each section, still retaining that each operational block is blind about the final goal of the system, and its process is determined by the e-information.

FIG. 12 shows a variant of the converter of the invention including a pus 130 between the operational blocks 101, 102, 103, 104, 105, 110 and so on. The sub-units of FIG. 12 are functionally equivalent to those carrying the same reference number in FIG. 2. The bus permits a connection among all the blocks meaning that each of them can receive/transmit signals from/to another block of the system in an arbitrary order that change dynamically.

The proposed architecture allows to use twice or more times the same block for the same section. It means that a given section could be processed by the same block more than one time. For example, if a given content is to be encrypted twice using two different keys, it can be processed twice by the same encoding block without resource duplications.

Let's assume that a given section after being processed by block 103, must be processed twice by block 104. Block 104 must perform on the section the same parameterizable process but using two different parameter values. For example: the section must be encrypted twice but using two different keys. In this example the encryption is the process and key is the parameter.

Block 103 processes the section and modify its e-information. After that, from the e-information both, block 104 and block 130, know that section must be processed by block 104. Block 104 performs the process using a given parameter value (a given key), changes the e-information and re-transmit the processed section to block 130. Block 130 knows, from the e-information, that the output must be re-injected in the block 104. Block 104 re-processes the section but, because of a different e-information, using another parameter value. Since block 104 is blind about the final goal of the system, it could ignore to process twice the same section.

Preferably, the sequence subunits operate on each section according to a program defined by the supervising controller 112 without knowledge of the previous and successive steps on the same section, and their action is of determined by the e-information inserted in the sections, for example by subunit 101. The supervising controller 112 is the only block that is aware of the sequence of processes performed on a given section.

The addressing of a section from a block to another is preferably based on an identifier in the e-information. At each block is assigned a given identifier. In this way the bus 130 knows the addressee of each section or, equivalently, each sub-unit can be programmed to recognize the section that are addressed to it, process them, and push them back on the bus 130. The programs imposed to the sub-units by the supervising controller 112 can include instructions to change the identifier in the e-information, thereby addressing the section to another operational block. In this way each section can be processed by the invention following a sequence of operations, executed by diverse sub-units, determined by the programs imposed to the subunits by the supervising controller 112.

The introduced flexibility does not impact the system ability of processing streams for QoS-System. Since the supervising controller knows the execution time of all the blocks, it knows the time needed to generate the output and then it can guarantee output streams suitable for QoS System. Both the architectures reported in FIG. 2 and FIG. 12 are able to guarantee deterministic execution time. The difference between them is the flexibility and the scalability. The process performed by the architecture of FIG. 12 can be dynamically changed from time to time and from section to section. Moreover new blocks can be easily added in the system, connecting their interface to the existing bus.

1. A digital converter for converting one or a plurality of input stream formatted signals into output streams, the input streams including a plurality of sections each of which may have one or more data fields for storing audio/video program data or other information, wherein the digital converter characterized by comprising:
an input unit, operatively arranged to insert in the sections of said one or a plurality of input stream a field of additional extrinsic data for the purposes of section identification and tagging, and to make the tagged sections available to a plurality of operational processing blocks; and
the operational processing blocks, wherein each of the operational processing blocks is arranged to select the section on which it must operate on the base of their extrinsic data, and to apply to the selected sections a process determined by their extrinsic data, wherein the operational processing blocks are arranged to modify the extrinsic data of the selected sections.

2. The digital converter of claim 1, wherein
the output streams are formatted as IP packets, and the converter includes one or several IP generators arranged to format the processed sections into IP packets.

3. The digital converter of claim 1, wherein the operational processing blocks are arranged in one chain or in a plurality of chains, wherein the sections pass from one operational block to a successive operational block in a chain, and the operational block are arranged to apply a process determined by the extrinsic data to the selected sections, and to forward transparently the other sections.

4. The digital converter of claim 1, wherein the operational processing blocks are interconnected by a bus on which the sections can be written and read, and the operational processing block are arranged to apply a process determined by the extrinsic data to the selected sections, and to write the processed sections on the bus.

5. (canceled)

6. The digital converter of claim 1, wherein at least some of said operational processing blocks are programmable and arranged to apply to selected section process defined by a program, or by register values set by a supervising controller of the digital converter.

7. The digital converter of claim 1, in which said operational processing blocks include a descrambler programmable to decrypt protected data present in the input transport streams and/or an encrypting unit programmable to apply a content-protection to selected sections.

8. The digital converter of claim 7, including an encrypting unit according to the DTCP standard.

9. An IP network comprising one or more nodes arranged to receive audio/video data in IP format and a digital converter according to claim 1.

10. A method to distribute audio/video programs inside an IP network, characterized by comprising:
receiving one or a plurality of input stream formatted signals including a plurality of sections each of which may have one or more data fields for storing audio/video program data or other information;
inserting in the sections of said one or a plurality of input stream a field of additional extrinsic data for the purposes of section identification and tagging;
making the tagged sections available to a plurality of operational processing blocks;
in each of the operational processing blocks, selecting section on which it must operate on the base of their extrinsic data;
in each of the operational processing blocks, applying to the selected sections a process determined by their extrinsic data; and
formatting the processed sections into IP packets,
wherein the operational processing blocks are arranged to modify the extrinsic data of the selected sections.
